(19) United States
(12) Patent Application Publication
(10) Pub. No.: US 2009/0133010 A1
(43) Pub. Date: May 21, 2009

(54) VIRTUALIZED BLADE FLASH WITH MANAGEMENT MODULE

(76) Inventors: Justin P. Bandholz, Cary, NC (US); Zachary B. Durham, Asheboro, NC (US); Clifton E. Kerr, Durham, NC (US); Joseph E. Maxwell, Cary, NC (US); Kevin M. Reinberg, Chapel Hill, NC (US); Kevin S. D. Vernon, Durham, NC (US); Phillip L. Weinstein, Apex, NC (US); Christopher C. West, Raleigh, NC (US)

Correspondence Address: HOFFMAN WARNICK LLC, 75 STATE STREET, 14TH FLOOR, ALBANY, NY, 12207, US

(21) Appl. No.: 11/943,886

(22) Filed: Nov. 21, 2007

(51) Int. Cl. G06F 15/177; G06F 9/44

(52) U.S. Cl. 717/168; 713/2; 713/1

(57) ABSTRACT

The invention is directed to providing a virtualized blade flash with a management module in a blade server. A method of configuring a blade server according to an embodiment of the invention includes: providing a plurality of blades, wherein each blade comprising: a service processor; a chip set; an at least one central processing unit (CPU); providing a management module in communication with each of the plurality of blades; and adding a virtual flash store at the management module.

### BACKGROUND OF THE INVENTION

1. Field of the Invention

The present invention generally relates to blade servers. More specifically, the present invention is directed to providing a virtualized blade flash with a management module.

2. Related Art

Currently, while blade servers must have their own flash image for each blade for loading at boot, the flash image does not get accessed once a system is up and running. Although this flash store is not performance-critical, nonetheless most applications still have it located close to the main chipset. These flash stores both consumer valuable board space and add cost to the blades. Another shortcoming is that updating BIOS flash across multiple blades is time-consuming, despite the fact that the image being loaded is often indistinguishable from one blade to the next blade.

A typical system, or blade server 10, having multiple blades 12 is shown in FIG. 1. Each blade 12 typically has a service processor (e.g., baseboard management controller (BMC)) 22 in communication with a chipset (e.g., northbridge 16, southbridge 18) and at least one CPU 14. The BMC 22 is also connected with a super input/output unit (Super I/O) 20 which communicates with basic input output system (BIOS) flash, or flash read only memory (ROM), 24. The server 10, in addition to the plurality of blades 12, includes a server chassis which includes a management module 30, wherein the BMC 22 communicates with the management module 30 via a midplane 26. While this type of system, or blade server, has a great deal of redundancy in componentry, there is not a concomitant redundancy in function, in terms of the BIOS flash 24 store.

Accordingly, there is an opportunity to address the aforementioned shortcomings, and possibly others, in the art of blade servers.

### SUMMARY OF THE INVENTION

The present invention is directed to providing a virtualized blade flash with a management module.

A first aspect of the present invention is directed to a method of configuring a blade server, comprising: providing a plurality of blades, wherein each blade comprising: a service processor; a chip set; and at least one central processing unit (CPU); providing a management module in communication with each of the plurality of blades; and adding a virtual flash store at the management module.

A second aspect of the present invention is directed to an apparatus comprising: a plurality of blades, wherein each blade comprising: a service processor; a chip set; and at least one central processing unit (CPU); a management module in communication with each of the plurality of blades, wherein the management module includes a virtual flash.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a block diagram of a blade center according to the related art.

FIG. 2 shows a block diagram of a blade center according to an embodiment of the invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, aspects of the invention provide an improved solution for blade servers, wherein a virtualized blade flash is provided at a management module. A method of configuring a blade server according to an embodiment of the invention includes: providing a plurality of blades, wherein each blade comprising: a service processor; a chip set; and at least one central processing unit (CPU); providing a management module in communication with each of the plurality of blades; and adding a virtual flash store at the management module.

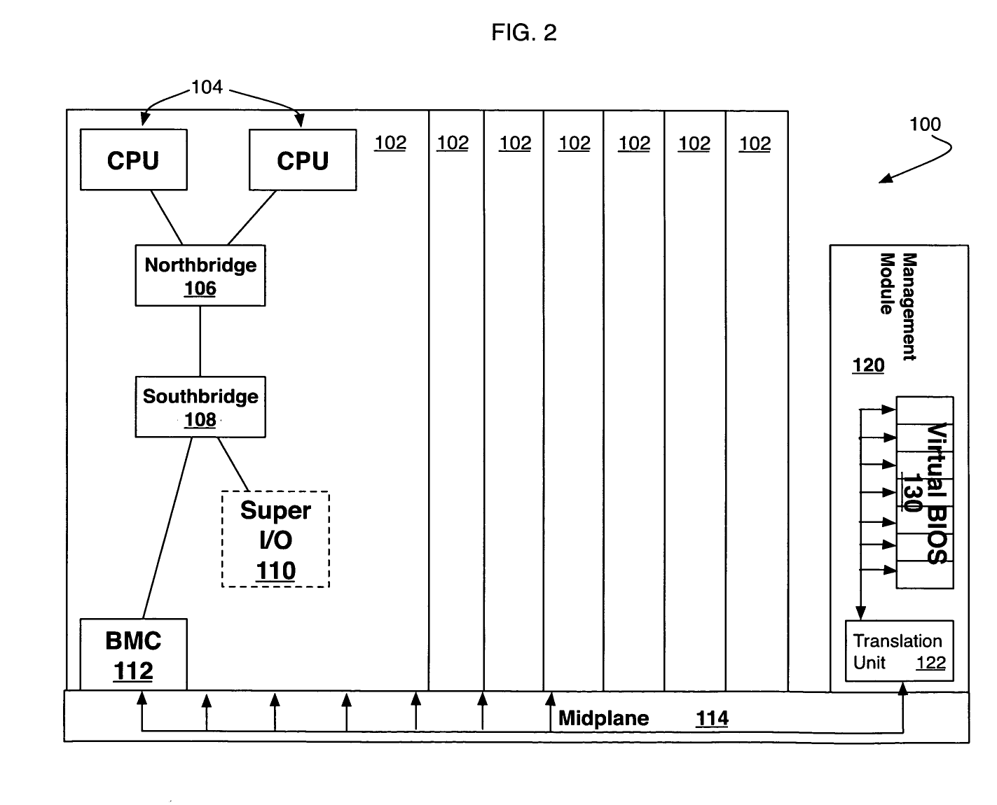

Turning to the drawings, FIG. 2 shows an illustrative block diagram of a computer system (e.g., blade server) 100 for providing a virtualized blade flash within a management module according to an embodiment of the invention. To this extent, computer system 100 includes a plurality of blades 102 each comprising a baseboard management controller (BMC) 112 in communication with a management module 120 via midplane 114. Each blade 102 further includes at least one CPU 104, a chip set (e.g., northbridge 106, southbridge 108), and a super I/O 110. The chipset 106, 108 connects directly to the BMC 112 when requesting BIOS data. The BMC 112, in turn, requests the BIOS page from the management module 120 over, for example, ethernet, high-speed link, and/or the like. On the management module 120, the request is converted back to a page read, which is offset to the location of the BIOS image for the requesting blade 102 and the data is sent back to the requesting blade 102.

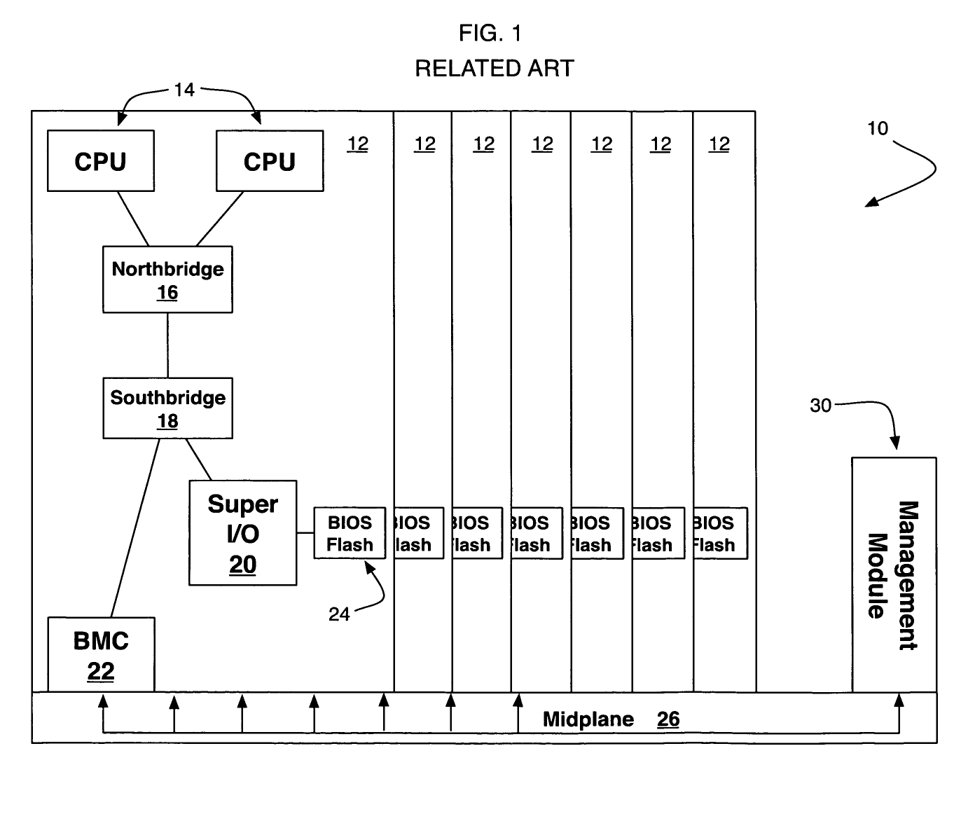

A management module 120 is part of the server 100 chassis and communicates, via midplane 114, with the BMC 112. Under aspects the present invention a flash memory (e.g., virtual BIOS) 130 is added to the management module 120 of the blade server 100, wherein the flash memory 130 is dedicated to storing the basic input output system (BIOS) images for all the blades 102 in that server 100 chassis. Concomitantly, all local BIOS flash 24 (FIG. 1) are removed from the individual blades 102. The chip set 106, 108 is thereby made to bridge to the remote flash memory 130 at boot and retrieve the image stored therein across the midplane 114 at boot. In this manner, with the exception of possibly additional latency and requiring blades 102 to be installed in a chassis that has a management module 120 installed as well, the linking under aspects of the present invention may function similarly to that with BIOS ROM locally installed (FIG. 1).

The flash store 130 may be suitably sized so as to contain a set of BIOS image spaces, each large enough to hold an image of a BIOS for each and every blade 102. The flash store 130 may further contain a listing of pointers for each blade 102. Upon a blade 102 requesting a BIOS page, the flash store 130 would access the pointer for the requesting blade 102 and retrieve the page from the image space indicated. Updates to the flash store 130 may be done directly through a management console and could affect anywhere from one (1) to conceivably all blades 102 with a new BIOS image the next time a boot is conducted.

In this manner, a virtualized flash store for BIOS images (e.g., virtual BIOS 130) is located in the management module 120 of a blade chassis, rather than on the individual blades 102. The invention thereby offers both material cost and board space savings. By virtualizing the flash ROM, it can be updated directly through an interface to the management module 120, and not requiring individualized installation on each blade 102. Virtualization of the flash ROM also allows multiple blades 102 to use the same BIOS image, thereby reducing configuration time in environments where multiple blades 102 of the same configuration and purpose exist in a single server 100 chassis.

The present invention can be implemented on any now known or later developed computer system that is capable of executing computer program code. The computer program code can be provided on a computer-readable medium or provided in any other suitable manner.

The foregoing description of the embodiments of this invention has been presented for purposes of illustration and description. It is not intended to be exhaustive or to limit the invention to the precise form disclosed, and many modifications and variations are possible.

What is claimed is:

1. A method of configuring a blade server, comprising:
providing a plurality of blades, wherein each blade comprising:
a service processor;
a chip set; and
at least one central processing unit (CPU);
providing a management module in communication with each of the plurality of blades; and
adding a virtual flash store at the management module.

2. The method of claim 1, wherein the virtual flash store comprises:
a basic input output system (BIOS) image of each blade; and
a list of pointers for each blade.

3. The method of claim 1, further comprising providing an interface at the management module, the interface configured to allow updating of a BIOS image at the virtual flash store.

4. An apparatus comprising:
a plurality of blades, wherein each blade comprising:
a service processor;
a chip set; and
at least one central processing unit (CPU);
a management module in communication with each of the plurality of blades, wherein the management module includes a virtual flash.
